(19) United States
(12) Patent Application Publication
(10) Pub. No.: US 2005/0217380 A1
(43) Pub. Date: Oct. 6, 2005

(54) Device for measuring structure-born noise

(75) Inventor: Ruediger Nebelsiek, Stuttgart (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/099,126

(22) Filed: Apr. 5, 2005

(30) Foreign Application Priority Data
Apr. 6, 2004 (DE) 10 2004 016 804.0

(51) Int. Cl. G01N 29/28; G01H 1/12; G01N 29/14

(52) U.S. Cl. 73/587; 73/594

(57) ABSTRACT

A device for measuring structure-borne noise has a measuring sensor (10) for detecting the structure-borne noise and a coupling element (11) connected to the measuring sensor (10) for reducing interference noises which act upon the measuring sensor (10) at least during measured-value detection. The coupling element (11) has an adjustable coupling strength in order to enable measured-value detection that is as flexible and reliable as possible.

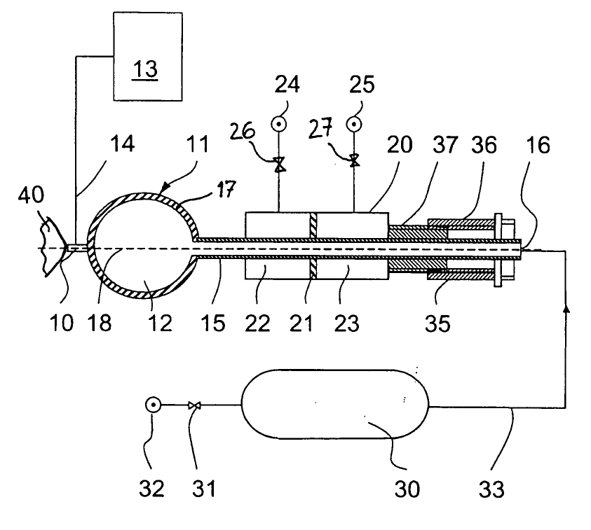

Priority is claimed to German Application Serial No. DE 10 2004 016 804.0, filed Apr. 6, 2004, the entire disclosure of which is incorporated herein.

The present invention is directed to a device for measuring structure-borne noise having a measuring sensor for detecting the structure-borne noise and a coupling element connected to the measuring sensor for reducing interference noises which act upon the measuring sensor at least during measured-value detection.

### BACKGROUND

It is known to use acoustic test technology for quality monitoring in work pieces and equipment assemblies. Indications of defects may be obtained from a structure-borne noise measurement. However, the signal-to-disturbance ratio is frequently unfavorable in such structure-borne noise measurements due to the normally high noise level.

For solving this problem, German Patent No. DE 43 16 473 C2 proposes decoupling a measuring sensor, which is in contact with the part to be tested, from interference noises via a plastic tubular clamp, the interference noises being conveyed via a mount of the measuring sensor.

### SUMMARY OF THE INVENTION

An object of the present invention is to provide a device for measuring structure-borne noises enabling improved interpretation of measured values and being usable as variably as possible.

In a device according to the present invention for measuring structure-borne noise using a measuring sensor for sensing the structure-borne noise and a coupling element, connected to the measuring sensor, the coupling element has an adjustable coupling strength, i.e., depending on the requirements, the coupling element may decouple possible interference noises, which are conveyable via a mount of the measuring sensor, to a greater or lesser extent. This enables an adaptation, a continuously variable adaptation in particular, of decoupling characteristics and damping characteristics to an intended variable and to the conditions prevailing during the measurement. The acoustic test quality depends on a plurality of parameters such as shape, wall thickness, material, internal pressure, characteristics of the damping fluid (density, viscosity in particular), hardness of the coupling element, the measuring sensor and/or a pressing path of the measuring sensor with regard to the part to be tested. In the ideal case, the measuring sensor is only in contact with the part to be tested, at the same time, however, it must be mechanically held and, if needed, it must be movable with respect to the part to be tested. The coupling element separates the measuring sensor, which may be pressed onto the part to be tested by a preferably predefinable force, from its mount by keeping interference noises away from the measuring sensor due to its damping characteristics and largely decoupling the measuring sensor from the surroundings. The measuring sensor is preferably designed in the form of a prod and is put in contact with the part to be tested. Of course, other types of measuring sensors are also conceivable. Those skilled in the art shall select a sensible measuring sensor for the appropriate measuring task. The coupling element is preferably designed as a hollow part having an elastic outer skin, in the form of a rubber ball for example.

Overall, an improved interpretation of test results is possible so that a well-founded evaluation of the quality of the part to be tested is possible in a preferably automated or at least semi-automated acoustic test process. This is particularly favorable during tests in vehicle construction, in particular during tests of equipment assemblies, such as engines, transmissions, and the like, in which a production rate as high as possible with error rates as low as possible is desired.

For adjusting the coupling strength, the coupling element is favorably able to be pressurized by a damping fluid, the coupling element, in an advantageous embodiment, being able to be pressurized by the damping fluid via a piston rod of a cylinder, in particular a hollow space of the coupling element is able to be filled with damping fluid. Air or compressed air may be provided as the damping fluid, for example.

A storage unit for the damping fluid may be appropriately provided. A shutoff valve is provided in a favorable refinement in such a way that the storage is able to be decoupled from a media supply during the reception of structure-borne noise. In particular, a control response of a possible pressure controller in a compressed air line, which fills the storage, may be eliminated as an interference variable.

A cylinder which is preferably designed as a double-action cylinder including a continuous piston rod may be provided in order to adjust a contact pressure of the coupling element for measured-value detection. By pressurizing one or the other of two cylinder chambers, the piston rod may be displaced in the one or the other direction so that a contact pressure of the measuring sensor onto the part to be tested may be decreased or increased. The coupling element is preferably connected to the piston rod of the cylinder. A pressure, which is exerted on the coupling element, also affects the measuring sensor connected to the coupling element. For measured-value detection, a change in the contact pressure of the coupling element at the measuring sensor and thus an indirectly resulting change in the contact pressure between the measuring sensor and the part to be tested may also take place in addition to the pressurization of the coupling element with damping fluid. This makes a specific optimization of the measuring signal with respect to interference variables possible by searching for an optimum, for example, when one or both of the parameters coupling strength and/or contact pressure is/are changed.

A comfortable and reliable measurement is possible if a control element is provided for adjusting a distance between the measuring sensor and a part to be tested. The distance may preferably be continuously adjustable.

### BRIEF DESCRIPTION OF THE DRAWINGS

The present invention is subsequently explained in greater detail based on an exemplary embodiment described in the drawing. The drawing, the description, and the claims contain a plurality of features in combination which those skilled in the art shall also consider individually and form into further sensible combinations.

The sole FIGURE schematically shows a device for measuring structure-borne noise according to the present invention.

### DETAILED DESCRIPTION

The FIGURE shows a measuring sensor 10 designed as a prod which radially protrudes from an outer skin 17 of a coupling element 11 designed as a hollow sphere. Measuring sensor 10 may be put in contact with a part to be tested 40, shown schematically here. Via a signal path 14, measuring sensor 10 is connected to an electronic unit 13 which processes a measured value recorded by measuring sensor 10 and/or relays it to a possible analyzer unit and which possibly electrically supplies the measuring sensor 10. Signal path 14 may be formed by a cable or may also be a wireless signal transmission. A transmitter is provided on measuring sensor 10 in the latter case.

Coupling element 11 has a hollow space 12 which is filled with a damping fluid. Outer skin 17 is preferably elastic, made of an elastomer for example. Hollow space 12 is in fluid-connection with a storage unit 30 which is designed as an accumulator and in which the damping fluid is stored. The fluid connection is formed via a hollow piston rod 15 of a cylinder 20, a pneumatic or hydraulic cylinder in particular, coupling element 11 being connected to the piston rod 15. Via a connecting line 33, the damping fluid arrives in a bore 16, which is continuous along its longitudinal extension, of piston rod 15 which meets hollow space 12 of coupling element 11.

A coupling strength of coupling element 11 is adjustable by filling hollow space 12 of coupling element 11 with more or less damping fluid, i.e., the hollow space is more or less pressurized. This changes the coupling characteristics between measuring sensor 10 and the other components of the device according to the present invention connected to coupling element 11. Depending on the amount and the pressure of the damping fluid, damping of coupling element 11 vis-à-vis noise waves from the outside is higher or lower.

A separator 21, which is fixedly connected to piston rod 15, separates cylinder 20 inside into a first cylinder chamber 22 and second cylinder chamber 23. First cylinder chamber 22 is supplied with a fluid from a media supply 24 and second cylinder chamber 23 is supplied with a fluid from a media supply 25. Air is preferably used as the fluid. Hydraulic oil may optionally also be used. Cylinder chambers 22, 23 may be decoupled with respect to media supplies 24, 25 with the aid of two valves 26, 27, thereby suppressing interferences which are caused by the control response of the pressure regulators for the cylinder movement.

Cylinder 20 is provided in order to adjust a contact pressure of coupling element 11 for measured-value detection. For measured-value detection, a change in the contact pressure of coupling element 11 onto measuring sensor 10 and thus an indirectly resulting change in the contact pressure between measuring sensor 10 and the part to be tested 40 may also take place in addition to the pressurization of coupling element 11 with damping fluid. This makes a specific optimization of the measuring signal with respect to interference variables possible.

A shutoff valve 31 is able to be shut at least during a measurement of structure-borne noise at an object to be tested in order to decouple storage 30 from a media supply 32 when structure-borne noise is recorded. The media supply is preferably a compressed air supply source.

Measuring sensor 10, cylinder 20 and its piston rod 15 are situated along an axis 18. A control element 35, via which a distance between measuring sensor 10 and a part to be tested is adjustable, adjoins to the side of cylinder 20 facing away from coupling element 11. A continuous adjustment is possible by twisting a first part 36, designed as a nut, vis-à-vis a second part 37, designed as a tube having a male thread. This may be carried out manually, or an electrical drive or another type of drive considered to be sensible by those skilled in the art may be provided. A pressing path of measuring sensor 10 is preferably continuously adjustable when the device is positioned at the part to be tested and measuring sensor 10 is to be put in contact with the part in a defined manner. The pressing path represents another parameter which, for optimizing the measuring result, is adjustable and possibly alignable with the coupling strength of coupling element 11 and/or the contact pressure of measuring sensor 10.

1. A device for measuring structure-borne noise comprising:
a measuring sensor for detecting the structure-borne noise; and
a coupling element connected to the measuring sensor for reducing interference noises acting upon the measuring sensor at least during measured-value detection,
the coupling element having an adjustable coupling strength.

2. The device as recited in claim 1 wherein the coupling element is pressurizable with a damping fluid for adjusting the coupling strength.

3. The device as recited in claim 2 wherein the coupling element has a hollow space fillable with the damping fluid.

4. The device as recited in claim 1 further comprising a cylinder for adjusting a contact pressure of the coupling element for measured-value detection.

5. The device as recited in claim 4 wherein the cylinder includes a piston rod, the coupling element pressurizable with the damping fluid via the piston rod.

6. The device as recited in claim 2 further comprising a storage unit for the damping fluid.

7. The device as recited in claim 6 further comprising a shut-off valve for decoupling the storage unit from a supply source during detection of structure-borne noise.

8. The device as recited in claim 1 further comprising a control element for adjusting a distance between the measuring sensor and a part to be tested.

9. The device as recited in claim 8 wherein the distance is continuously adjustable.

10. A method for measuring structure-borne noise comprising:
measuring structure borne-noise via a measuring sensor; and
reducing interference noises acting upon the measuring sensor during the measuring step using a coupling element connected to the measuring sensor, the reducing step including adjusting a coupling strength of the coupling element.
